(19) United States
(12) Patent Application Publication
(10) Pub. No.: US 2016/0275583 A1
(43) Pub. Date: Sep. 22, 2016

(54) System and Method for Product Customization and Production

(71) Applicant: Bayerische Motoren Werke Aktiengesellschaft, Muenchen (DE)

(72) Inventor: Charles CAMBIANICA, Roubaix (FR)

(21) Appl. No.: 14/659,195

(22) Filed: Mar. 16, 2015

(51) Int. Cl. G06Q 30/06; G05B 15/02; B29C 67/00; G06F 17/50; G06F 3/0484

(52) U.S. Cl. CPC G06Q 30/0621; G06F 17/50; G06F 3/04847; G06F 3/04845; G06F 3/04842; B29C 67/0088; G05B 15/02; B33Y 50/02

(57) ABSTRACT

A customization platform, implemented in an online environment, enables users to define configuration values corresponding to a physical appearance of a customizable product. The user-defined configuration values are used to generate and update, in real time, a computer model of the product that is generated by a backend server. Image data based on the computer model is then provided by the backend server to the user, also in real time, via a graphical user interface of a client-side device. Once the user is done customizing the product, a final set of configuration values for the product is transmitted to a production device of the platform, which then proceeds to produce the customizable product in accordance with that final set of configuration values.

### FIELD OF THE INVENTION

The present invention relates to product customization, and more particularly to a system and method for providing real-time, online product customization and production.

### BACKGROUND

There is an ever-increasing desire to provide customers with the ability to tailor certain products to their individual likings and needs. It is widely believed that the most satisfied customers are those that have had the most input into the design and configuration process of the products they purchase. Moreover, the more choices a customer is given, the more likely it is that she will be able to find a product offering that satisfies all or most of the features/characteristics in which she is interested.

With the above principles in mind, various approaches to providing users with the ability to customize products online have been attempted. Most of those prior art approaches, however, are unable to provide the user with an accurate visual representation of any changes the user makes to the product. Others attempt to accurately depict a customized product, but are unable to do in real time. And all of those approaches suffer from a complete disconnect between the frontend customization process, on the one hand, and the backend modeling and production processes, on the other hand.

Therefore, there is a need for an improved system and method for providing real-time, online product customization and production.

### BRIEF SUMMARY OF THE INVENTION

Disclosed and claimed herein is a system and method for producing a customized product. In one embodiment, the method includes transmitting, by a server to one or more client-side devices over a network, image data for a customizable product, where the image data is based on a computer model of a customizable product that is generated using default configuration values corresponding to a physical appearance of the customizable product. An image of the customizable product, based on the image data, is to be displayed via a graphical user interface of the one or more client-side devices.

The method further includes receiving, by the server via the graphical user interface over the network, one or more user-definable configuration values corresponding to the physical appearance of the customizable product, and updating, by the server in real time, the computer model of the customization product in response to receiving the one or more user-definable configuration values. In addition, updated image data of the customizable product is transmitted, by the server to the one or more client-side devices over the network, in response to the computer model being updated. The updated image data is based on the updated computer model, and an updated image based on the updated image data is to be displayed via the graphical user interface of the one or more client-side devices.

The above method further includes transmitting, by the server to a production device, a final set of configuration values corresponding to the physical appearance of the customizable product, and finally producing, by the production device, the customizable product in accordance with the final set of configuration values received from the server.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a simplified block diagram of an exemplary system and network environment in which a product customization and production platform, configured in accordance with the principles of the invention, is operable;

FIGS. 2A-2D depict various graphical user interfaces usable to carry out one or more aspects of the invention;

FIG. 3 is an example of another graphical user interface usable in connection with one or more embodiments of the invention; and

FIG. 4 depicts a process for carrying out one or more aspects of the invention.

### DETAILED DESCRIPTION OF EXEMPLARY EMBODIMENTS

### Overview of the Disclosure

The following disclosure relates to a novel platform, including a system and method which utilizes the platform, across which end users can customize, in real time, products that are produced in accordance with configuration values provided by the end users themselves.

The invention relates to enabling users to define configuration values corresponding to a physical appearance of a customizable product. The user-defined configuration values are used to generate and update, in real time, a computer model of the product that is generated by a backend server. Image data based on the computer model is then provided by the backend server to the user, also in real time, via a graphical user interface of a client-side device. Once the user is done customizing the product, a final set of configuration values for the product is transmitted to a production device of the platform, which then proceeds to produce the customizable product in accordance with that final set of configuration values.

As used herein, the term “server” refers to any computerized component, system or entity regardless of form which is adapted to provide data, files, applications, content, or other services to one or more other devices or entities on a computer network. The term “database” refers generally to one or more tangible or virtual data storage locations, which may or may not be physically co-located with each other or other system components.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, A, B or C means any of the following: A; B; C; A and B; A and C; B and C; A, B and C. An exception to this definition will occur only when a combination of elements, functions, steps or acts are in some way inherently mutually exclusive. Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable storage medium, which may include any medium that can store information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Network Overview

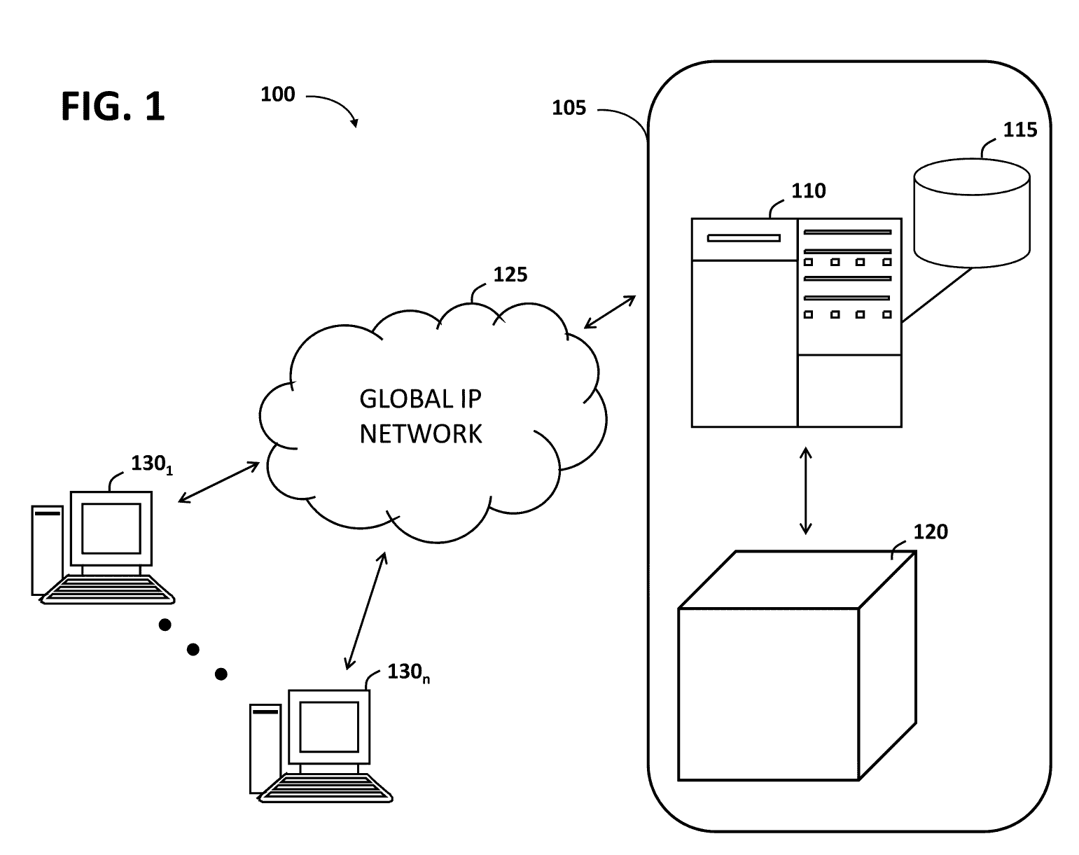

With reference to FIG. 1, the simplified communication system diagram depicts a product customization and production platform 105 that is configured to implement one or more aspects of the invention. As shown, the platform 105 includes a platform server 110, which may be coupled to or otherwise in electronic communication with the platform database 115. The platform database 115 may contain product customization data, and related information for facilitating the product customization and production process. It should be appreciated that the platform server 110 may be implemented as a single server (as shown in FIG. 1) or as several interlinked servers.

Product customization and production platform 105 further comprises at least one production device 120 that is in electrical communication with platform server 110. Production device 120 may comprise a 3D printer or other known rapid prototyping machine that employs “additive layer technology” to produce three dimensional products, e.g., selective laser melting or direct metal laser sintering, selective laser sintering, fused deposition modeling, stereolithography, laminated object manufacturing, etc. Alternatively, production device 120 may comprise a 2D production device, such as a laser engraving device or a stamping machine.

Continuing to refer to FIG. 1, the depicted system further comprises a plurality of client-side devices 130₁-130n (collectively, “130”) which may comprise virtually any computing device (e.g., personal computer, tablet, smartphone, etc.) that includes a display screen and is configured to execute an Internet browser-type application that accesses and receives data from the platform server 110 and associated platform database 115 and displays a graphical user interface (GUI) in response. The client-side devices 130 may be configured to access the platform server 110 and associated platform database 115 over a global IP network 125 (e.g., the Internet).

### Exemplary Embodiments of the Invention

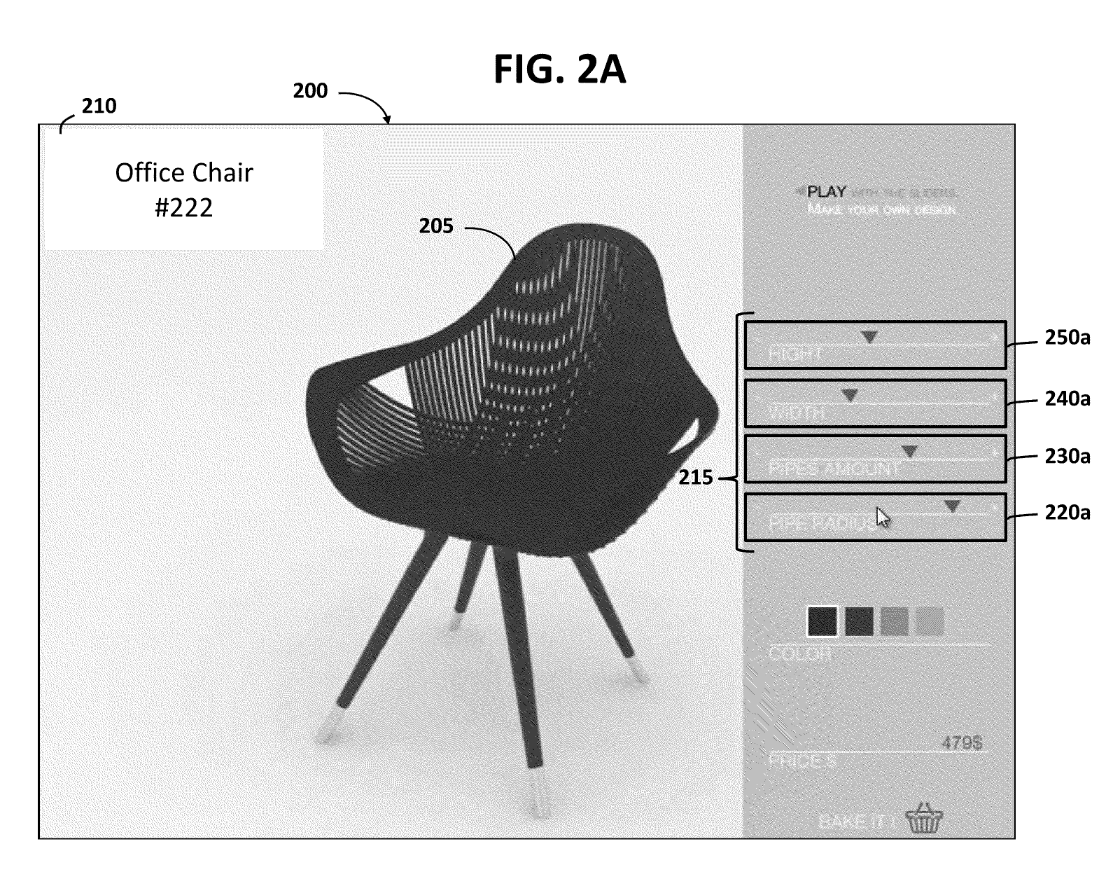

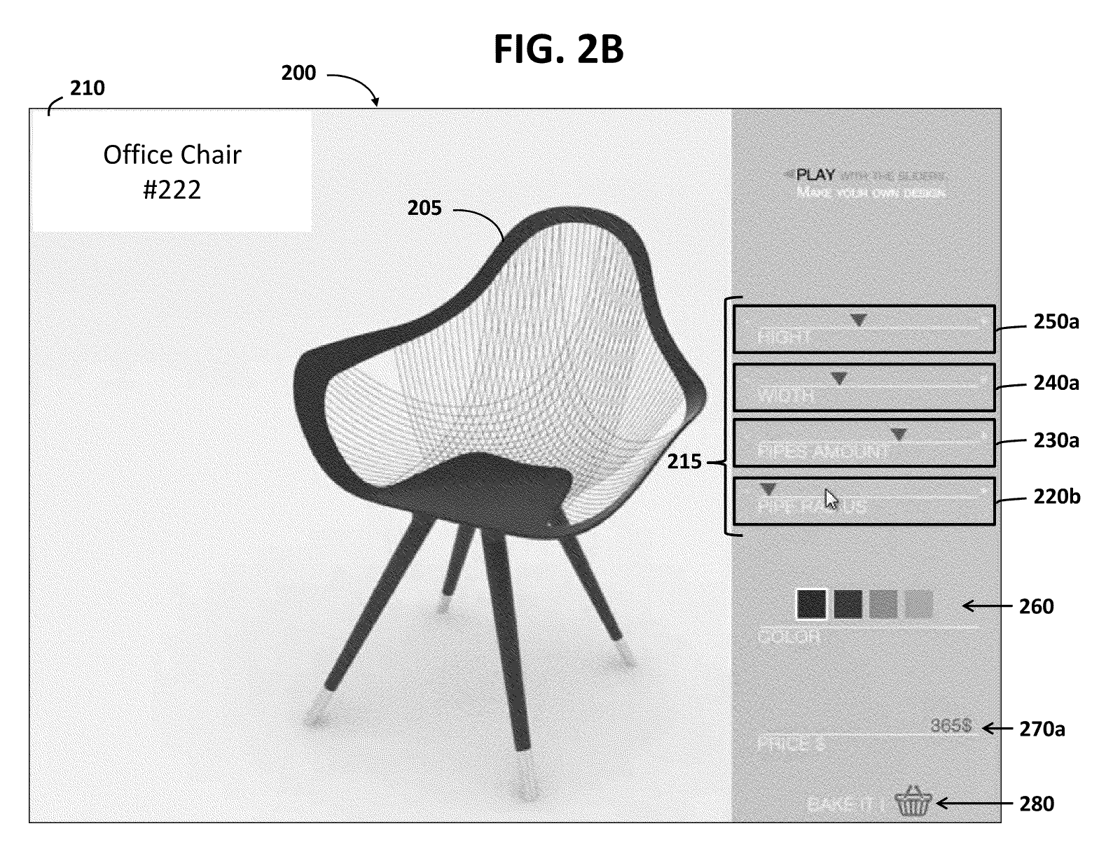

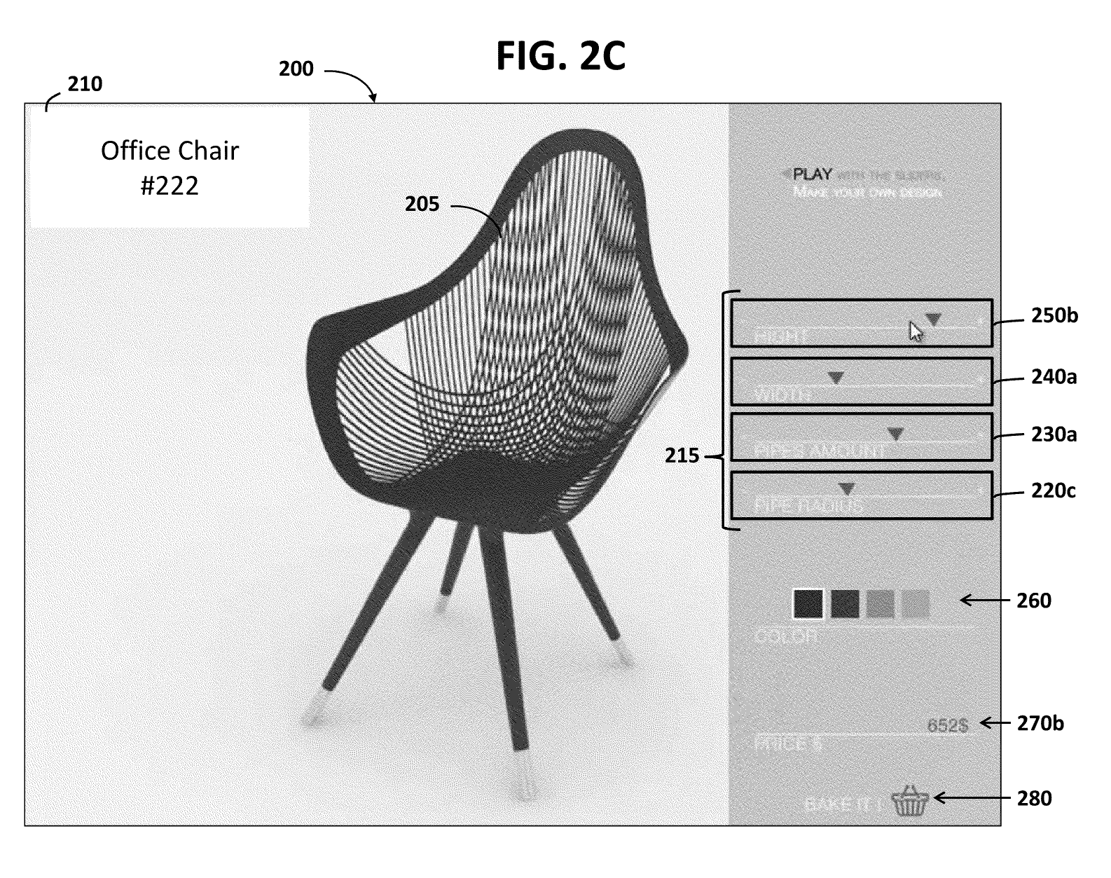

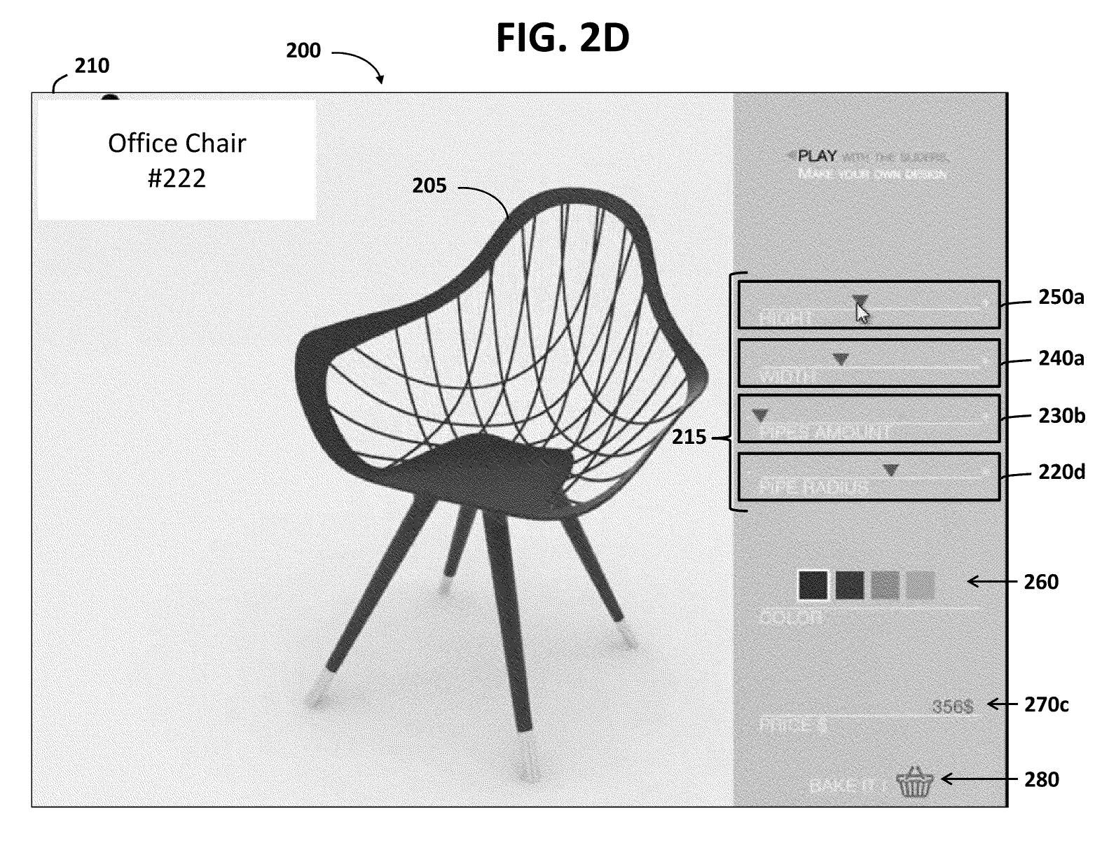

FIGS. 2A-2D depict various GUIs usable to carry out one or more aspects of the invention. It should be appreciated that, while the exemplary product being customized in the example of FIGS. 2A-2D is an office chair, the principles of the invention would extend to virtually any product, whether three dimensional or two dimensional in nature.

Referring first to FIG. 2A, depicted is a representation of a GUI 200 displayable on a display screen of a client-side device, such as client-side device 130 of FIG. 1. In certain embodiments, the GUI 200 may be rendered by an Internet browser-type application executing on the client-side device based on information received from a backend server (e.g., server 110) over a network (e.g., network 125). GUI 200 may be part of an online store front or other online product offering websites.

As shown in FIG. 2A, GUI 200 comprises an image 205 for a customizable product, which in this example is an office chair. Product identification information 210, which provides some information about the customizable product, may also be displayed as part of GUI 200. In certain embodiments, it may be preferable for the customizable product image 205 to be based on default configuration values corresponding to a physical appearance of the customizable product 205. The default configuration values, which may be stored in a server-side database (e.g., database 115) may be set by a manufacturer of the customizable product, or may be based on known user preferences, whether specific to the particular user or based on aggregate known user preferences.

Regardless of how the default user preferences are established, GUI 200 further includes a plurality of graphical sliders 215, each of which corresponds to a configuration value associated with a physical characteristic of the customizable product, and each of which is configured to be user adjustable. In the particular embodiment of FIG. 2A, the graphical sliders 215 include a pipe radius slider corresponding to a configuration value for the radius of the pipes that comprise the chair's sitting surface (having an initial default configuration value 220a), a pipe amount slider corresponding to a configuration value for the density of pipes that comprise the sitting surface (having an initial default configuration value 230a), a width slider corresponding to a configuration value for an overall width dimension for the chair (having an initial default configuration value 240a) and a height slider corresponding to a configuration value for an overall height dimension for the chair (having an initial default configuration value 250a).

In one or more preferred embodiments, the range along which the user may adjust the product's configuration values (e.g., using slides 215) may be constrained by one or more physical characteristics of the product (such minimum stability requirements, maximum available width or height, maximum height/width ratio, etc.), or may be constrained by aesthetic-based considerations. As with the default configuration values noted above, the configuration value ranges, i.e., minimum and maximum values, may also be stored in a server-side database (e.g., database 115).

In one or more preferred embodiments, the current configuration values, whether default or user-defined via sliders 215, are algorithmically linked to a three dimensional or two dimensional computer model of the customizable product that is generated, and maintained during the product customization process, on a backend server (e.g., platform server 110) with which the client-side device is in communication. As the configuration values are altered, data representing those adjustments may be transmitted to a modeling module executing on the backend server, and then used to update, in real time, the actual three dimensional or two dimensional computer model of the product that is being maintained on the backend server during the product customization process. In turn, it should be appreciated that, as the computer model of the product is updated by the backend server in response to any user adjustments of the product's configuration values, image data corresponding to that updated computer model may be transmitted from the backend server to the client-side device and used to update, also in real time, the product image 205 on GUI 200. Thus, by selecting and dragging one or more of the plurality of sliders 215, a user can customize the physical appearance of an actual product and see, in real time, the visual manifestation of any modifications the user makes to the physical appearance of the customized product.

By way of example and with reference to FIG. 2B, the product image 205 shown in GUI 200 has been updated to reflect the fact that the user has adjusted the slider for the pipe radius configuration value from its default configuration value 220a (from FIG. 2A) to a new, user-defined configuration value 220b. Specifically, the pipe radius slider has been adjusted by the user to a much lower value, near the lower limit of the possible pipe radius slider. As a result, the pipe radii across the sitting surface of the chair are much thinner, as represented in real time by the updating of product image 205. As noted above, the product image 205 is updated by virtue of the fact that this new pipe radius value would be transmitted to the backend server that is maintaining a three dimensional computer model of the chair. Since each of the configuration values, including the pipe radius value, is algorithmically linked to the product's computer model on the backend server, the computer model can be updated to reflect the new pipe radius, and image data corresponding to the updated computer model can then be transmitted, in near real time, from the backend device to the client-side device and displayed as an updated image 205.

In addition to the configuration value sliders 215, FIG. 2B further illustrates other user-selectable options that may also be provided via the GUI 200. For example, a color selector 260 may be used to define the product's color. In addition, an as-configured product price 270a may be displayed as well. In certain embodiments, the as-configured product price 270a may be updated in real time, along with the product image 205, to reflect the current/user-defined configuration values. Finally, the GUI 200 may further set forth a user-selectable icon 280 (e.g., “Bake It” button) by which the user can end the customization process and commence product production.

Referring now FIG. 2C, depicted is the product image 205 after being updated in real time to reflect the fact that the user has adjusted the pipe radius slider down from the previous user-defined configuration value 220b of FIG. 2B to a new user-defined configuration value 220c. As can be seen from both a comparison of the product images 205 in each of FIGS. 2A-2C, as well as the relative position of the pipe radius slide in each of FIGS. 2A-2C, the user-defined pipe radius value 220c is larger than the user-defined pipe radius configuration value 220b of FIG. 2B, but still smaller than the original default configuration value 220a (FIG. 1A). In this fashion, a user can iteratively fine tune the customization of virtually any given product.

Moreover, in the embodiment of FIG. 2C, the height value slider has been adjusted from the default configuration value 250a of FIG. 1, to a new, higher configuration value 250b. As a result of this further user-defined customization, the height of the chair has been increased, as represented in real time by the updating of product image 205 of FIG. 2C.

As a result of the further user adjustments of the configuration values associated with the customizable product, the as-configured product price has been similarly updated, along with the product image 205, from the initial price 270a to a new, current product price 270b that reflects the current/user-defined configuration values. Finally, as before, the user is again presented with a user-selectable icon 280 by which the user can end the customization process and commence product production.

Referring now to FIG. 2D, depicted is the product image 205 after it has been again updated in real time to reflect the fact that the user has now (i) returned the height configuration value of the chair to its default configuration value 250a, (ii) increased the slider for the pipe radius configuration value from the previous user-defined configuration value 220c to yet another new user-defined configuration value 220b, and (iii) significantly decreased the pipe amount configuration value from its default configuration value 230a to a new user-defined configuration value 230b. As a result of these further user adjustments, the as-configured product price has been updated, along with the product image 205 itself, to a new, current product price 270c which again reflects the current/user-defined configuration values in real time.

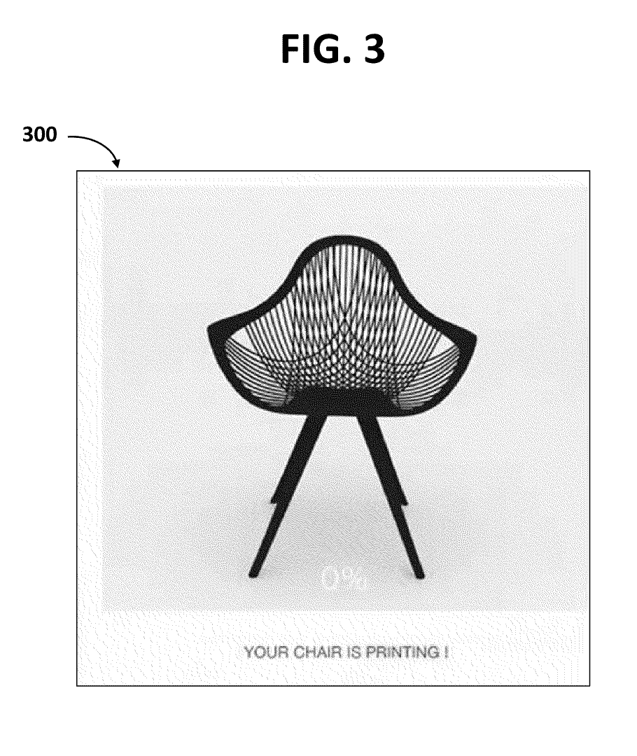

Referring now to FIG. 3, depicted is one example of a GUI 300 which may be displayed on a client-side device (for example, in response to a user selection of icon 280 as labeled in each of FIGS. 2B-2D) to indicate that the customization process has ended and that the product production process is underway.

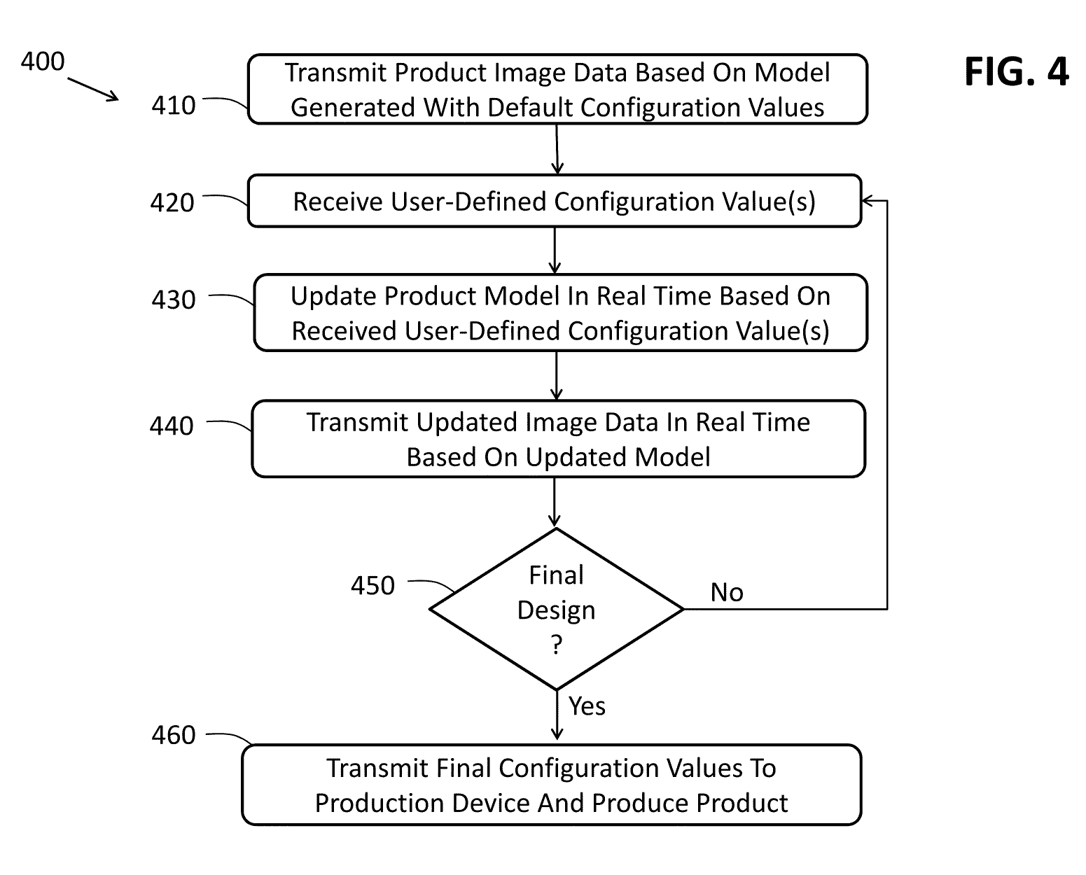

Referring now to FIG. 4, depicted is one embodiment of a process for producing a customized product in accordance with the principles of the invention. Process 400 begins at block 410 where image data for a customizable product is transmitted by a server (e.g., platform server 110) to one or more client-side devices (e.g., devices 130) over a network (e.g., network 125). In certain embodiments, the image data may be based on a computer model of a customizable product that is generated using default configuration values corresponding to a physical appearance of the customizable product. As noted above, the computer model may be generated by a backend server (e.g., platform server 110) and the default configuration values may be stored in a server-side database (e.g., database 115). It should further be appreciated that the image data may be used by a client-side device to display an image, representative of the customizable product, via a GUI displayed on a display screen of the one or more client-side devices. In certain embodiments, the product image may be rendered by an Internet browser-type application, executing on the client-side device, based on the image data received from a backend server, and the GUI may be part of an online store front or other online product offering website.

Once the image data has been transmitted to one or more client-side devices and corresponding product images displayed thereon, process 400 may continue to block 420 where one or more user-definable configuration values corresponding to the physical appearance of the customizable product may be provided to and received by the backend server via the graphical user interface over the network. As noted above, user-defined configuration values may be provided, for example, using graphical sliders (e.g., sliders 215), each of which corresponds to a configuration value associated with a particular physical characteristic of the customizable product. Moreover, it may be preferable to constrain the range along which the user may adjust the product's configuration values based on, for example, one or more physical limitations or aesthetic-based considerations. Minimum and maximum configuration values may also be stored in a server-side database (e.g., database 115), and used by the backend server to constrain the means by which the user is permitted to enter the user-defined configuration values.

Process 400 may continue to block 430 where the computer model of the customization product that has been generated by the backend server may be updated, in real time, in response to receiving the one or more user-definable configuration values.

Once the computer model has been updated, process 400 may continue to block 440 where updated image data of the customizable product may be transmitted by the server to the one or more client-side devices in response to the updated computer model. In particular, the updated image data is preferably based on the updated computer model. An updated image of the customizable product, based on the updated image data, can then be displayed via the graphical user interface of the one or more client-side devices.

Thereafter, a determination may be made at block 450 as to whether the currently-configured product represents the user's desired final design, or whether the user may be interested in making further modifications to the design. While this determination may be made based on whether the user has selected a particular button/icon associated with the completion of the customization process (e.g., user-selectable “Bake It” button 280), it may similarly be based on any number of other criteria, such as time elapsed, etc.

If it is determined at block 450 that the customization process has not yet ended, then process 400 may revert to block 420 where further updates to the user-definable configuration values may be awaited and, when received, acted upon in the manner outlined above with respect to blocks 430 and 440. However, once it is determined at block 450 that the customization process is complete, process 400 may then proceed to block 460 where a final set of configuration values defining the physical appearance of the customizable product may be transmitted from the server to a production device. And, in response, the production device may begin a production process by which the customizable product is created in accordance with the final set of configuration values received from the server.

As noted above, it should be appreciated that the production device, which may be part of a product customization and production platform (e.g., platform 105) may comprise a 3D printer or other known rapid prototyping machine that employs “additive layer technology” to produce three dimensional products, e.g., selective laser melting or direct metal laser sintering, selective laser sintering, fused deposition modeling, stereolithography, laminated object manufacturing, etc. Alternatively, in the event the customized product is a two dimensional product, the production device may comprise a 2D production device, such as a laser engraving device or a stamping machine. In this fashion, end users can customize, online and in real time, products that are produced in accordance with configuration values provided by the end users themselves.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A product customization and production platform comprising:
a server coupled to a network, wherein the server is configured to communicate with one or more client-side devices over the network, and wherein the server includes processing circuitry to execute programming code to,
transmit, over the network to the one or more client-side devices, image data for a customizable product, where the image data is based on a computer model of a customizable product that is generated using default configuration values corresponding to a physical appearance of the customizable product, wherein an image of the customizable product, based on the image data, is to be displayed via a graphical user interface of the one or more client-side devices,
receive, via the graphical user interface from the one or more client-side devices over the network, one or more user-definable configuration values corresponding to the physical appearance of the customizable product,
update, in real time, the computer model of the customization product in response to receiving the one or more user-definable configuration values,
transmit, over the network to the one or more client-side devices, updated image data of the customizable product in response to the updated computer model, wherein the updated image data is based on the updated computer model and wherein an updated image based on the updated image data is to be displayed via the graphical user interface of the one or more client-side devices, and
transmit, to a production device, a final set of configuration values corresponding to the physical appearance of the customizable product; and
the production device, configured to receive the final set of configuration values and, in response, to produce the customizable product in accordance therewith.

2. The platform of claim 1, wherein one or more user-definable configuration values correspond to at least one physical dimension of the customizable product.

3. The platform of claim 2, wherein one or more user-definable configuration values are constrained by one or more physical characteristics of the product.

4. The platform of claim 1, wherein the server includes processing circuitry to execute programming code to further display, on the graphical user interface of the one or more client-side devices, a plurality of graphical sliders, wherein the one or more user-definable configuration values are definable by user adjustment of a corresponding one or more of the plurality of graphical sliders.

5. The platform of claim 4, wherein each of the plurality of sliders is configured to be user adjustable between a corresponding predefined range of configuration values.

6. The platform of claim 1, wherein the production device is a rapid prototyping device.

7. The platform of claim 6, wherein the production device is one of a laser engraving device and a stamping machine.

8. The platform of claim 6, wherein the customizable product is a three dimensional product.

9. The platform of claim 8, wherein the production device is a 3D printer.

10. A method for producing a customized product comprising the acts of:
transmitting, by a server to one or more client-side devices over a network, image data for a customizable product, where the image data is based on a computer model of a customizable product that is generated using default configuration values corresponding to a physical appearance of the customizable product, wherein an image of the customizable product, based on the image data, is to be displayed via a graphical user interface of the one or more client-side devices;
receiving, by the server via the graphical user interface over the network, one or more user-definable configuration values corresponding to the physical appearance of the customizable product;
updating, by the server in real time, the computer model of the customization product in response to receiving the one or more user-definable configuration values;
transmitting, by the server to the one or more client-side devices over the network, updated image data of the customizable product in response to said updating the computer model, wherein the updated image data is based on the updated computer model and wherein an updated image based on the updated image data is to be displayed via the graphical user interface of the one or more client-side devices;
transmitting, by the server to a production device, a final set of configuration values corresponding to the physical appearance of the customizable product; and
producing, by the production device, the customizable product in accordance with the final set of configuration values received from the server.

11. The method of claim 10, wherein one or more user-definable configuration values correspond to at least one physical dimension of the customizable product.

12. The method of claim 11, wherein one or more user-definable configuration values are constrained by one or more physical characteristics of the product.

13. The method of claim 10, further comprising displaying, on the graphical user interface of the one or more client-side devices, a plurality of graphical sliders, wherein the one or more user-definable configuration values are definable by user adjustment of a corresponding one or more of the plurality of graphical sliders.

14. The method of claim 13, wherein each of the plurality of sliders is configured to be user adjustable between a corresponding predefined range of configuration values.

15. The method of claim 10, wherein the production device is a rapid prototyping device.

16. The method of claim 15, wherein the production device is one of a laser engraving device and a stamping machine.

17. The method of claim 15, wherein the customizable product is a three dimensional product.

18. The method of claim 17, wherein the production device is a 3D printer.
